(19) United States
(12) Patent Application Publication
(10) Pub. No.: US 2007/0166588 A1
(43) Pub. Date: Jul. 19, 2007

(54) Membrane-electrode assembly for solid polymer electrolyte fuel cell and method for producing the same

(75) Inventors: Nagayuki Kanaoka, Saitama (JP); Hiroshi Sohma, Saitama (JP); Masaru Iguchi, Saitama (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/643,817

(22) Filed: Dec. 22, 2006

(30) Foreign Application Priority Data
Jan. 13, 2006 (JP) 2006-005547

(51) Int. Cl. H01M 8/10; B05D 5/12

(52) U.S. Cl. 429/30; 429/33; 427/115

(57) ABSTRACT

A membrane-electrode assembly for solid polymer electrolyte fuel cells is provided which has a solid polymer electrolyte membrane having a high concentration of protonic acid groups enabling high proton conductivity and high humid condition, along with superior dimensional stability, without the membrane-electrode assembly dissolving in hot water. The membrane-electrode assembly for solid polymer electrolyte fuel cells was formed by using a polymer electrolyte composition consisting of a polymer having a cross-linking structure, this polymer electrolyte composition being obtained from a mixed solution that includes a polymer electrolyte containing a protonic acid group, a compound containing plurality of ethylenic unsaturated groups, and a solvent.

This application is based on and claims the benefit of priority from Japanese Patent Application No. 2006-005547, filed on 13 Jan. 2006, the content of which is incorporated herein by reference.

### BACKGROUND OF THE INVENTION

1. Field of the Invention

The present invention relates to a membrane-electrode assembly for solid polymer electrolyte fuel cells and method for producing the same.

2. Related Art

A fuel cell is a clean, environment friendly power generating system with high electrical efficiency, and which has been attracting a great deal of attention as earth environmental protection and break away from dependence on fossil fuels in recent years, and it is desired that a fuel cell be mounted in a small distribution power generating facility, a power generating device as a driving force of a movable body, such as a vehicle or vessel. Furthermore, the fuel cell is desired to replace a second battery such as a lithium ion battery that mounted in a mobile phone, a mobile personal computer, or the like.

In a fuel cell using a polymer electrolyte and a polymer electrolyte membrane in an electrode layer, having a positive ion generated at a negative pole and efficiently and quickly conducted from the polymer electrolyte to the electrolyte membrane, and to a positive pole via the polymer electrode membrane, is an important factor that enhances power generation performance. Therefore, since a polymer electrolyte with superior cation conductivity is required, the concentration of protonic acid groups that exemplified by a sulfonate group in the polymer electrolyte is preferably as high as possible.

In addition, unless the polymer electrolyte and the electrolyte membrane are used in humid conditions, the positive ion conductivity deteriorates and polarization occurs, which deteriorates the performance. Therefore, in order to find a way for increasing the concentration of protonic acid groups in the polymer electrolyte, having sufficient water retentivity, many experiments have been performed. (For example, Japanese Unexamined Patent Application Publication No. 2004-51685 (hereinafter referred to as Patent Document 1), Japanese Unexamined Patent Application Publication No. 2005-63778 (hereinafter referred to as Patent Document 2), Japanese Unexamined Patent Application Publication No. 2005-139318 (hereinafter referred to as Patent Document 3), and Japanese Unexamined Patent Application Publication No. 2005-113051 (hereinafter referred to as Patent Document 4). In this manner water retentivity is increased and the humid condition is indirectly maintained, thereby achieving the desired improvements in critical current density, simplification of the humidifier, and power generation performance.

However, in cases in which the concentration of protonic acid groups in the polymer electrolyte, and the polymer electrolyte and the electrolyte membrane come in contact with hot water generated when the solid polymer electrolyte fuel cell generates power, dimension deformation is increased by swelling and dissolving. Thus, in a low temperature environment, electrodes are detached by shrinkage of the electrolyte membrane, so that the preferable power generation performance may not be obtained. In addition, when the electrolyte membrane is dissolved to form a pin hole, both electrodes short, so that a phenomenon occurs in which power cannot be generated. Thus, the concentration of protonic acid groups in the polymer electrolyte used fuel cell is limited to subject to the power generation performance.

### SUMMARY OF THE INVENTION

The object of the present invention is to provide the membrane-electrode assembly for solid polymer electrolyte fuel cells that exhibits superior dimensional stability to high temperature of hot water generated on power generation, and excellent power generation performance and durability under a low temperature environment.

As a result of vigorous efforts to solve the abovementioned problem, we have found that the polymer electrolyte membrane including a polymer electrolyte composition, in which a compound having a plurality of ethylenic unsaturated groups is added in the polymer electrolyte with a protonic acid group, and cross-linking reacted with the compound, develops higher proton conductivity and has a higher stability to hot water to satisfy the object of the present invention. Specifically, the present invention provides the membrane-electrode assembly for solid polymer electrolyte fuel cells as described below.

According to a first aspect of the present invention, a membrane-electrode assembly for solid polymer electrolyte fuel cells includes an anode electrode, a cathode electrode, and a solid polymer electrolyte membrane, the anode electrode and the cathode electrode are disposed on opposite sides of the solid polymer electrolyte membrane, in which, the solid polymer electrolyte membrane includes a polymer electrolyte composition consisting of a polymer having a cross-linking structure, and the solid polymer electrolyte composition is obtained from a mixed solution that includes a polymer electrolyte containing a protonic acid group, a compound containing the plurality of ethylenic unsaturated groups, and a solvent.

According to a second aspect of the present invention, in the membrane-electrode assembly for solid polymer electrolyte fuel cells described in the first aspect of the present invention, the compound containing the plurality of ethylenic unsaturated group is a polyfunctional unsaturated monomer that contains a plurality of (metha)acryloyl groups or vinyl groups in its molecule.

According to a third aspect of the present invention, in the membrane-electrode assembly for solid polymer electrolyte fuel cells described in the first aspect of the present invention, the solid polymer electrolyte containing the protonic acid group includes a sulfonated polyarylene having constitutional units expressed by the general formulas (A) and (B) shown below.

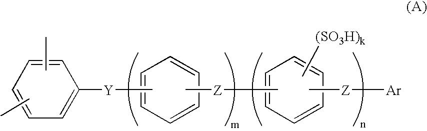

In the formula (A), Y represents —CO—, —SO₂—, —SO—, —CONH—, —COO—, —(CF₂)ᵢ— (i is an integer from 1 to 10) and —C(CF₃)₂—; Z independently represents a direct bond, —O—, —S—, —(CH₂)ⱼ— (j is an integer from 1 to 10), or —C(CH₃)₂—; Ar represents an aromatic group having a substituent expressed by —SO₃H, —O(CH₂)ₚSO₃H or —O(CF₂)ₚSO₃H (p is an integer from 1 to 12); m is an integer from 0 to 10; n is an integer of 0 to 10; and k is an integer from 1 to 4.

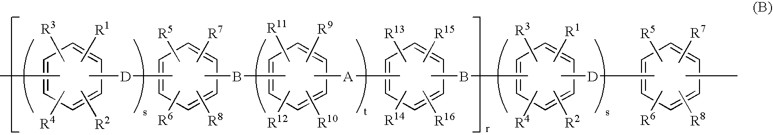

In the formula (B), A and D each independently represents a direct bond, —O—, —S—, —CO—, —SO₂—, —SO—, —CONH—, —COO—, —(CF₂)ᵢ— (i is an integer from 1 to 10), —(CH₂)ⱼ— (j is an integer from 1 to 10), —CR′₂— (R′ represents an aliphatic hydrocarbon group, aromatic hydrocarbon group, or halogenated hydrocarbon group), cyclohexylidene group, or fluorenylidene group; B independently represents an oxygen atom or sulfur atom; R¹ to R¹⁶ each independently represents a hydrogen atom, fluorine atom, alkyl group, partly or fully halogenated alkyl group, allyl group, aryl group, nitro group, or nitrile group; s and t are integers from 0 to 4; and r is an integer of 0 or more.

According to a fourth aspect of the present invention, in the membrane-electrode assembly for solid polymer electrolyte fuel cells described in the third aspect of the present invention, the sulfonated polyarylene has an ion exchange capacity of 0.3 to 5 meq/g.

According to a fifth aspect of the present invention, in the membrane-electrode assembly for solid polymer electrolyte fuel cells described in the third aspect of the present invention, the sulfonated polyarylene has a molecular weight of 10,000 to 1,000,000.

According to a sixth aspect of the present invention, in the membrane-electrode assembly for solid polymer electrolyte fuel cells described in the first aspect of the present invention, the mixed solution has a viscosity of 1,000 to 20,000 mPa·s.

According to a seventh aspect of the present invention, in the membrane-electrode assembly for solid polymer electrolyte fuel cells described in the first aspect of the present invention, the mixed solution further contains a polymerization initiator.

According to an eighth aspect of the present invention, in the membrane-electrode assembly for solid polymer electrolyte fuel cells described in the seventh aspect of the present invention, the polymerization initiator generates a radical by being decomposed by way of photoirradiation.

According to a ninth aspect of the present invention, in the membrane-electrode assembly for solid polymer electrolyte fuel cells described in the seventh aspect of the present invention, the polymerization initiator is a thermal polymerization initiator.

According to a tenth aspect of the present invention, in the membrane-electrode assembly for solid polymer electrolyte fuel cells described in any one of the first to ninth aspects of the present invention, the polymer having a cross-linking structure is obtained by initiating a cross-linking reaction in the compound containing the plurality of ethylenic unsaturated groups that forms the mixed solution.

According to an eleventh aspect of the present invention, a method for producing a membrane-electrode assembly for solid polymer electrolyte fuel cells includes steps of: applying the mixed solution described in any one of the first to ninth aspect of the present invention onto a substrate to form a dried coating film; and initiating the cross-linking reaction in the compound containing the plurality of ethylenic unsaturated groups that forms the coating film.

The polymer electrolyte membrane including the polymer electrolyte composition of the present invention that consists of a polymer having a cross-linking structure has a higher concentration of protonic acid groups, less swelling from hot water, and lower solubility to hot water. Thus, when this polymer electrolyte membrane is used, higher proton conductivity is developed, and higher humidity is maintained, so that electric resistance can be reduced to obtain the solid polymer electrolyte fuel cell exhibiting a higher power generation output.

### DETAILED DESCRIPTION OF THE INVENTION

The membrane-electrode assembly for solid polymer electrolyte fuel cells according to the present invention will be explained below in more detail.

### Mixed Solution

The mixed solution according to the present invention includes a polymer electrolyte containing a protonic acid group, a compound containing a plurality of ethylenic unsaturated groups, and a solvent. Polymer Electrolyte Containing Protonic Acid Group The polymer electrolyte containing the protonic acid group forming the mixed solution of the present invention has a protonic acid group in its molecular chain, and is formed from a polymer with 10,000 or more of molecular weight. The protonic acid group is not particularly limited, for example, a sulfonate acid group, a phosphonic acid group, a carboxylic acid function, and the like are included, and may be in combination thereof. Among these, a sulfonic acid group and a phosphonic acid group are preferred, and a sulfonic acid group is more preferred from the viewpoint of high proton conductivity.

The structure of the protonic acid group is not limited in particular; however, preferably a polymer structure that hardly deteriorates under an oxidation-reduction atmosphere at a higher temperature in a fuel cell. The polymer having such a preferable structure includes, for example, a polymer having a fluorine atom. The polymer having a fluorine atom is particularly not limited, for example, polyvinyl fluoride (PVF), polyvinylidene fluoride (PVDF), polyhexafluoropropylene (FEP), polytetrafluoroethylene, polyperfluoroalkylvinyl ether (PFA), and the like are included. In addition, a copolymer thereof, a copolymer of a monomer unit thereof and another monomer, such as styrene and ethylene, and furthermore a blend thereof can be used.

Furthermore, another polymer having the abovementioned preferable structure includes a polymer used as an engineering plastic having superior oxidation resistance and heat resistance. Specifically, polyimide (PI), polyphenylene sulfide sulfone (PPSS), polysulfone (PSF), polyphenylene sulfide (PPS), polyphenylene oxide (PPO), polyetherketone (PEK), polyetheretherketone (PEEK), polyethersulfone (PES), polyether ether sulfone (PEES), polybenzimidazole (PBI), polyarylene and the like are included. In addition, a polymer having this kind of structure can be used alone, or blended to be used, and furthermore, these structures can be block-copolymerized, random-copolymerized or graft-copolymerized to be used.

### Sulfonated Polyarylene

The polymer electrolyte containing a protonic acid group used in the present invention is preferably a block copolymer in which a polymer segment having an ion conductive component such as a sulfonate group and a polymer segment having no ionic conductive components are covalently bonded. A polyarylene having a structure, in which an aromatic ring is covalently bonded to a bonding group in a main chain skeleton forming the copolymer, is more preferred. Preferably in particular, a polyarylene having a sulfonic acid group expressed by the general formula (C), which includes a constitutional unit expressed by the general unit (A) n(hereinafter sometimes referred to as “sulfonic acid unit” or “constitutional unit (A)”), and a constitutional unit expressed by the general formula (B) (hereinafter sometimes referred to as “hydrophobic unit” or “constitutional unit (B)”), is particularly preferred, and hereinafter referred to as “sulfonated polyarylene”.

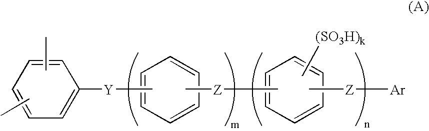

In the formula (A) described above, Y represents —CO—, —SO₂—, —SO—, —CONH—, —COO—, —(CF₂)ᵢ— (i is an integer from 1 to 10) and —C(CF₃)₂—; and among these, —CO— and —SO₂— are preferred. Z independently represents a direct bond, —O—, —S—, —(CH₂)ⱼ— (j is an integer from 1 to 10), or —C(CH₃)₂—; and among these, a direct bond and —O— are preferred. Ar represents an aromatic group having a substituent expressed by —SO₃H, —O(CH₂)ₚSO₃H or —O(CF₂)ₚSO₃H (p is an integer from 1 to 12). Examples of the aromatic groups include phenyl, naphthyl, anthryl and phenanthryl groups. Among these, phenyl and naphthyl groups are preferred. In addition, Ar should have at least one substituent expressed by —SO₃H, —O(CH₂)ₚSO₃H or —O(CF₂)ₚSO₃H; preferably, in case in which Ar is a naphthyl group, it has two or more substituents. m is an integer from 0 to 10, preferably 0 to 2; n is an integer from 0 to 10, preferably 0 to 2; and k is an integer from 1 to 4.

Examples of preferred structures of constitutional unit (A) include:

(i) m=0, n=0, Y is —CO—, Ar is a phenyl group with a substituent of —SO₃H;

(ii) m=1, n=0, Y is —CO—, Z is —O—, and Ar is a phenyl group with a substituent of —SO₃H;

(iii) m=1, n=1, k=1, Y is —CO—, Z is —O—, and Ar is a phenyl group with a substituent of —SO₃H;

(iv) m=1, n=0, Y is —CO—, and Ar is a naphthyl group with two substituents of —SO₃H; and

(v) m=1, n=0; Y is —CO—, Z is —O—, and Ar is a phenyl group with a substituent of —O(CH₂)₄SO₃H.

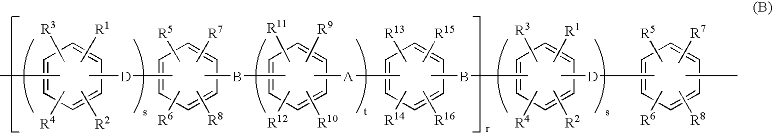

In the formula (B), A and D each independently represents from a direct bond, —O—, —S—, —CO—, —SO₂—, —SO—, —CONH—, —COO—, —(CF₂)ᵢ— (i is an integer from 1 to 10), —(CH₂)ⱼ— (j is an integer from 1 to 10), —CR′₂—, cyclohexylidene group, or fluorenylidene group are preferred; and among these, preferably a direct bond, —O—, —CO—, —SO₂—, —CR′₂—, cyclohexylidene group, and fluorenylidene group. R′ represents an aliphatic hydrocarbon group, an aromatic hydrocarbon group, or a halogenated hydrocarbon group; for example, a methyl, ethyl, propyl, isopropyl, butyl, isobutyl, t-butyl, propyl, octyl, decyl, octadecyl, phenyl, and trifluoromethyl groups, and the like are included. B independently represents an oxygen atom or sulfur atom, and among these, an oxygen atom is preferred. R¹ to R¹⁶ each independently represents a hydrogen atom, fluorine atom, alkyl group, partly or fully halogenated alkyl group, allyl group, aryl group, nitro group or nitrile group. Examples of the alkyl groups in the R¹ to R¹⁶ include methyl, ethyl, propyl, butyl, amyl, hexyl, cyclohexyl, octyl groups, and the like. Examples of the halogenated alkyl groups include trifluoromethyl, pentafluoroethyl, perfluoropropyl, perfluorobutyl, perfluoropentyl perfluorohexyl groups, and the like. An example of the allyl group includes a propenyl group. Examples of the aryl groups include phenyl, pentafluorophenyl groups, and the like. s and t are integers from 0 to 4. r is an integer of 0 or more, preferably 1 to 80, and the upper limit is usually 100.

Examples of preferred structures of the constitutional unit (B) include:

(i) s=1, t=1, A is —CR′₂—, a cyclohexylidene group or fluorenylidene group, B is an oxygen atom, D is —CO— or —SO₂—, and R¹ to R¹⁶ are hydrogen or fluorine atom;

(ii) s=1, t=0, B is oxygen atom, D is —CO— or —SO₂—, R¹ to R¹⁶ are hydrogen atoms or fluorine atoms; and

(iii) s=0, t=1, A is —CR′₂—, a cyclohexylidene group or fluorenylidene group, B is an oxygen atom, and R¹ to R¹⁶ are hydrogen atoms, fluorine atoms or nitrile groups.

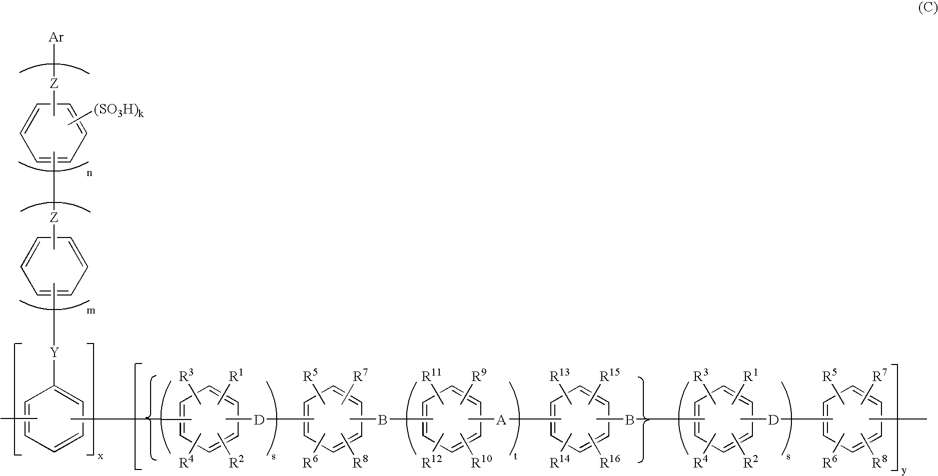

In the formula (C): A, B, D, Y, Z, Ar, k, m, n, r, s, t and R¹ to R¹⁶ are the same as those defined in the abovementioned formulas (A) and (B), and x and y represent a mole ratio in which X+Y=100 mole %.

The sulfonated polyarylene preferably used in the present invention contains the constitutional unit (A), i.e. the unit x, in 0.5 to 100 mole %, preferably 10 to 99.999 mole %, and the constitutional unit (B), i.e. the unit y, in 0 to 99.5 mole %, preferably 0.001 to 90 mole %. Since the abovementioned sulfonated polyarylene has a hydrophilic portion with a sulfonic acid group, and a block structure consisting of a hydrophobic part without any sulfonic acid groups, a polymer electrolyte with less effluency and swelling in hot water can be obtained. Since the abovementioned sulfonated polyarylene has a block structure for forming a phase separation structure, sulfonic acid groups gather, resulting in an increase in proton conduction efficiency, so as to obtain superior power generating output when the sulfonated polyarylene is used. In addition, when the abovementioned sulfonated polyarylene is used as the membrane, it has superior creep resistance at a high temperature because of the high inflection point temperature, so that stable power generation performance with a long duration can be obtained, even if the membrane is used for fuel cells at a high temperature for a long time.

### Method for Producing Sulfonated Polyarylene

For example, a method for manufacturing the abovementioned sulfonated polyarylene includes Methods A, B, and C described below.

### Method A

A monomer, having a sulphonic ester group, capable of constituting the constitutional unit (A), and a monomer or oligomer capable of constituting the constitutional unit (B), are copolymerized, for example, in accordance with the method described in Japanese Unexamined Patent Application Publication No. 2004-137444, for example, and thereby a polyarylene having a sulfonic ester group is produced, and then the sulfonic ester group is de-esterified to be converted into a sulfonic acid group.

### Method B

A monomer having a skeleton expressed by the formula (A), having neither a sulfonic acid group nor a sulfonic ester group, and a monomer or oligomer capable of forming the constitutional unit (B) are copolymerized, for example, in accordance with the method described in Japanese Unexamined Patent Application Publication No. 2001-342241, and then the obtained copolymer is sulfonated by use of a sulfonating agent.

### Method C

In cases in which Ar is an aromatic group having a substituent expressed by —O(CH₂)ₚSO₃H and —O(CF₂)ₚSO₃H in the formula (A), a precursor monomer capable of constituting the constitutional unit (A) and a monomer or oligomer capable of constituting the constitutional unit (B) are copolymerized, for example, in accordance with the method as disclosed in Japanese Unexamined Patent Application Publication No. 2005-60625, and then an alkylsulfonic acid or a fluorine-substituted alkylsulfonic acid is introduced.

Examples of monomers used in Method A, which are capable of forming the constitutional unit (A) having a sulfonic ester group, include the sulfonic esters described in Japanese Unexamined Patent Application Publication Nos. 2004-137444, 2004-345997 and 2004-346163.

Specific examples of monomers used in the Method B, which are capable of forming the constitutional unit (A), having neither a sulfonic acid group nor a sulfonic ester group, include the dihalogenated compounds described in Japanese Unexamined Patent Application Publication Nos. 2001-342241 and 2002-293889.

Specific examples of precursor monomers, used in Method C, capable of constituting the constitutional unit (A), include the dihalogenated compounds described in Japanese Unexamined Patent Application Publication No. 2005-36125.

In cases in which r=0, specific examples of the monomers and oligomers which are capable of forming the constitutional unit (B), and used in any of the methods, include: 4,4′-dichlorobenzophenone, 4,4′-dichlorobenzanilide, 2,2-bis(4-chlorophenyl)difluoromethane, 2,2-bis(4-chlorophenyl)-1,1,1,3,3,3-hexafluoropropane, 4-chlorobenzoic acid-4-chlorophenylester, bis(4-chlorophenyl)sulfoxide, bis(4-chlorophenyl)sulfone, 2,6-dichlorobenzonitrile, and the like. These compounds, in which a chlorine atom is substituted with a bromine atom or iodine atom, may also be used. In cases in which r=1, the compounds, for example, described in Japanese Unexamined Patent Application Publication No. 2003-113136 may be used. In cases in which r is more than 2, the compounds described in Japanese Unexamined Patent Application Publication Nos. 2004-137444, 2004-244517, 2004-346164, and 2005-112985, and Japanese Patent Application Nos. 2004-211739 and 2004-211740 are included.

In order to obtain the polyarylene having a sulfonic acid group, it is necessary that a monomer capable of forming the constitutional unit (A) and a monomer or oligomer capable of forming the constitutional unit (B) be copolymerized in the presence of a catalyst to prepare a precursor polyarylene. The catalyst used in the abovementioned polymerization containing a transition metal compound, essentially contains: (i) a transition metal salt and a bonding group compound, or a transition metal complex with a coordinate bonding group(including copper salt); and (ii) a reducing agent, and additionally an optional “salt” that is added in order to increase the polymerization reaction rate. The specific examples of the catalyst components, contents of respective components in use, reaction solvents, concentration, temperature, period and the like employs conditions and the like as described, for example, in Japanese Unexamined Patent Application Publication No. 2001-342241.

The sulfonated polyarylene used in the present invention can be obtained by converting the precursor polyarylene, which is obtained as described above, into the polyarylene having the sulfonic acid group. Such methods may be exemplified in the following three methods.

### Method A′

The precursor polyarylene having the sulfonic ester group, which is obtained by way of the Method A is de-esterified in accordance with the method described in Japanese Unexamined Patent Application Publication No. 2004-137444.

### Method B′

The precursor polyarylene which is obtained by way of the Method B is sulfonated in accordance with the method described in Japanese Unexamined Patent Application Publication No. 2001-342241.

### Method C′

An alkylsulfonic acid group is introduced into the precursor polyarylene which is obtained by way of the Method C in accordance with the method as disclosed in Japanese Unexamined Patent Application Publication No. 2005-60625.

The ion-exchange capacity of the sulfonated polyarylene expressed by the formula (C) prepared in accordance with the abovementioned methods is usually 0.3 to 5 meq/g, preferably 0.5 to 3 meq/g, and more preferably 0.8 to 2.8 meq/g. However, when the ion-exchange capacity is less than the abovementioned range, the power generation performance tends to be insufficient due to lower proton conductivity. On the other hand, when it is more than the abovementioned range, water resistance may be remarkably degraded, so that it is not preferred. The ion-exchange capacity may be controlled, for example, by selecting types, the usage ratio, and combination of the precursor monomer capable of constituting the constitutional unit (A) and the monomer or oligomer capable of constituting the constitutional unit (B).

The molecular weight of the polyarylene having the sulfonic acid group obtained in these manners is 10,000 to 1,000,000, and is preferably 20,000 to 800,000, as the average molecular weight based on polystyrene standard by way of gel permeation chromatography (GPC).

### Compound Containing Unsaturated Groups

A compound that contains a plurality of ethylenic unsaturated groups forming the mixed solution of the present invention (hereinafter referred to as “unsaturated group containing compound”) is soluble in the solvent, has two or more ethylenic covalent bonds which has functionality in one molecule, and is used as a cross-linking agent. An example of such a compound includes a polyfunctional unsaturated monomer containing of a plurality of (metha)acryloyl groups or vinyl groups in its molecule.

Examples of the abovementioned polyfunctional unsaturated monomer include: divinylbenzene, ethylenedimethacrylate, N,N′-methylene bisacrylamide, adipic acid divinyl, trimethylolpropane tri(metha)acrylate, pentaerythritol tri(metha)acrylate, ethyleneglycol di(metha)acrylate, tetraethyleneglycol di(metha)acrylate, polyethyleneglycol di(metha)acrylate, 1,4-butanediol di(metha)acrylate, 1,6-hexanediol di(metha)acrylate, neopentylglycol di(metha)acrylate, trimethylolpropane trioxyethyl(metha)acrylate, tris(2-hydroxyethyl)isocyanuratetri(metha)acrylate, tris(acryloyloxy)isocyanurate, bis(hydroxymethyl)tricyclodecane di(metha)acrylate, dipentaerythritol hexa(metha)acrylate, di(metha)acrylate of diol which is a polyethyleneoxide or propyleneoxide adduct of bisphenol A, di(metha)acrylate of diol which is an ethyleneoxide or propyleneoxide adduct of hydrogenated bisphenol A, epoxy(metha)acrylate in which (metha)acrylate is added to diglycidylether of bisphenol A, and triethyleneglycol divinylether, and the like.

Examples of commercialized products of the unsaturated group containing compound include:

“Yupimer UV SA1002, SA2007” produced by Mitsubishi Chemical Corporation,

“Viscoat #195, #230, #215, #260, #335HP, #295, #300, #360, #700, GPT, 3PA” produced by OSAKA ORGANIC CHEMICAL INDUSTRY LTD.,

“LIGHT-ACRYLATE 4EG-A, 9EG-A, NP-A, DCP-A, BP-4EA, BP-4PA, TMP-A, PE-3A, PE-4A, DPE-6A” produced by KYOEISHA CHEMICAL Co., LTD,

“KAYARAD PET-30, TMPTA, R-604, DPHA, DPCA-20, -30, -60, -120, HX-620, D-310, D-330” produced by NIPPON KAYAKU CO., LTD.,

“ARONIX M208, M210, M215, M220, M240, M305, M309, M310, M315, M325, M400” produced by TOAGOSEI CO., LTD., and

“Ripoxy VR-77, VR-60, VR-90” produced by SHOWA HIGHPOLYMER CO., LTD.

### Composition Ratio

In the mixed solution of the present invention, the composition ratio of the polymer electrolyte and the unsaturated group containing compound is not limited in particular; however, when the contents of the unsaturated group containing compound is too much, dimensional stability of the polymer electrolyte membrane described below improves, but the concentration of protonic acid in the electrolyte membrane is decreased so that the proton conductivity is decreased. On the other hand, when the content of the unsaturated group containing compound is too low, the concentration of protonic acid groups in the electrolyte membrane does not change significantly, so that proton conductivity is maintained, without allowing the cross-linking reaction proceed sufficiently, thereby causing improved effect of the dimensional stability to be insufficient. Therefore, the composition ratio of the polymer electrolyte to the unsaturated group containing compound (polymer electrolyte:unsaturated group containing compound) is preferably from 70:30 to 99.99:0.01, more preferably from 80:20 to 99.9:0.1, and most preferably from 85:15 to 99:1

### Solvent

The mixed solution of the present invention includes a solvent which simultaneously dissolves a polymer electrolyte containing the protonic acid group and the compound containing the plurality of ethylenic unsaturated groups. Such a solvent varies depending on the combination of the polymer electrolyte and the unsaturated group containing compound. However, it is not particularly limited as long as the solvent can dissolve both the electrolyte and the compound, and then remove them.

As the solvent, for example, an aprotic solvent such as a combined solvent of water/lower alcohol (methanol, ethanol, normal propanol, or isopropanol), N,N-dimethylformamide, N,N-dimethylacetamide, N-methyl-2-pyrrolidone, and dimethylsulfoxide; a chlorinated solvent such as dichloromethane, chloroform, 1,2-dichloroethane, and chlorobenzene, dichlorobenzene; alcohols such as methanol, ethanol, and propanol; alkyleneglycol monoalkylethers such as ethyleneglycol monomethylether, ethyleneglycol monoethylether, and propyleneglycol monoethylether; ketones such as acetone, methylethylketone, cyclohexanone, and γ-butyrolactone; and ethers such as tetrahydrofuran and 1,3-dioxane are preferably used. These may be used alone or in combinations of two or more.

The mass ratio of the solute component consisting of the polymer electrolyte and the unsaturated group containing compound to the solvent dissolving thereof is not particularly limited, and varies depending on the kind of the polymer electrolyte, the unsaturated group containing compound, and the solvent, or the like. Typically, when the solvent ratio is high, it takes times to dry, and a homogeneous membrane thickness is difficult to obtain. On the other hand, when the solute component ratio is high, the drying time is shortened, so that it tends to be difficult to produce a membrane with an increased solution viscosity. Therefore, the mass ratio of the solute component to the solvent component is preferably from 2:98 to 40:60, more preferably from 5:95 to 35:65, and most preferably from 8:92 to 30:70.

The viscosity of the mixed solution of the present invention is not particularly limited; however, it is preferably 1,000 to 20,000 mPa·s, and more preferably 3,000 to 10,000 mPa·s, which is the appropriate viscosity required to obtain a homogeneous membrane material produced by way of a casting process.

### Other Components

In the mixed solution of the present invention, an antioxidant, preferably an additive such as a hindered phenol system compound having a molecular weight of 500 or more, other than the polymer electrolyte, the unsaturated group containing compound, and the polymerization initiator described below may be contained. By containing an antioxidant, the durability as the polymer electrolyte composition can be improved.

Hindered phenol system compounds according to the present invention include:

triethyleneglycol-bis[3-(3-t-butyl-5-methyl-4-hydroxyphenyl)propionate] (product name: IRGANOX 245),

1,6-hexanediol-bis [3-(3,5-di-t-butyl-4-hydroxyphenyl)propionate] (product name: IRGANOX 259),

2,4-bis-(n-octylthio)-6-(4-hydroxy-3,5-di-t-butylanilino)-3,5-triazine (product name: IRGANOX 565),

pentaerylthrityl-tetrakis[3-(3,5-di-t-butyl-4-hydroxyphenyl)propionate] (product name: IRGANOX 1010),

2,2-thio-diethylenebis[3-(3,5-di-t-butyl-4-hydroxyphenyl)propionate] (product name: IRGANOX 1035),

Octadecyl-3-(3,5-di-t-butyl-4-hydroxyphenyl)propionate) (product name: IRGANOX 1076),

N,N-hexamethylene bis(3,5-di-t-butyl-4-hydroxy-hydrocinnamamide) (product name: IRGANOX 1098),

1,3,5-trimethyl-2,4,6-tris(3,5-di-t-butyl-4-hydroxybenzyl)benzene (product name: IRGANOX 1330),

tris-(3,5-di-t-butyl-4-hydroxybenzyl)-isocyanurate (product name :IRGANOX 3114),

3,9-bis[2-{3-(3-t-butyl-4-hydroxy-5-methylphenyl)propionyloxy}-1,1-dimethylethyl]-2,4,8,10-tetraoxaspiro[5.5]undecane (product name: Sumilizer GA-80), and the like.

In the present invention, the hindered phenol compounds are preferably used in an amount of 0.01 to 10 parts by mass to the polymer electrolyte having a sulfone group.

### Polymer Electrolyte Composition

The polymer electrolyte composition of the present invention is prepared by using the abovementioned mixed solution of the present invention, and includes a polymer having a cross-linking structure obtained by initiating a cross-linking reaction in the unsaturated group containing the compound consisting of the mixed solution. By containing such a polymer having such a cross-linking structure, swelling, dissolving and pinholes occurring from high temperature water that exists by generating or humidifying on power generation are inhibited, and then dimensional stability of the electrolyte membrane in a fuel cell and assembly stability with electrodes are enhanced to obtain stable power generation performance.

The method for the cross-linking reaction is not particularly limited; for example, radiation cross-linking and heat cross-linking can be employed. The radiation herein means, for example, an ionizing radiation such as infra-red ray, a visible light ray, a UV ray, an X ray, an electron beam, an alpha ray, a beta ray, and a gamma ray; usually, a light such as a UV ray is easily used. When ethylenic unsaturated groups are reacted to be cross-linked each other by photoirradiation using such a radiation, a photo polymerization initiator and a photosensitizer may be added in the mixed solution as required.

The photo polymerization initiator is not particularly limited as long as a radical is generated by decomposition from photoirradiation to initiate polymerization reaction, and includes, for example, acetophenone, acetophenone benzylketal, 1-hydroxycyclohexylphenylketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoinpropyl ether, benzoinethyl ether, benzyldimethylketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-molforino-propane-1-one, 2,4,6-trimethylbenzoyldiphenylphosphine oxide, and bis-(2,6-dimethoxybenzoyl)-2,4,4-trimethylpentylphosphine oxide.

Examples of commercialized products of the photo polymerization initiator include:

“Irgacure 184, 369, 651, 500, 819, 907, 784, 2959, CGI-1700, -1750, -1850, CG24-61, Darocur 1116, 1173” produced by Ciba Specialty Chemicals,

“Lucirin TPO, LR8893, LR8970” produced by BASF AG, and

“Uvecryl P36” produced by UCB.

Examples of the photosensitizers include: triethylamine, diethylamine, N-methyldiethanolamine, ethanolamine, 4-dimethylaminobenzoic acid, 4-dimethylamino benzoic acid methyl, 4-dimethylaminobenzoic acid ethyl, 4-dimethylaminobenzoic acid isoamyl, and the like; and examples of commercialized products thereof include “Uvecryl P102, 103, 104, 105” produced by UCB and the like.

The mixture amount of the photo polymerization initiator to initiate the cross-linking reaction in the present invention is 0.01 to 10 mass%, preferably 0.5 to 7 mass% to the total amount of the mixed solution. The upper limit of the mixture amount is preferable within range from the viewpoint of curing characteristics, mechanical characteristic, and handling characteristics of a composite membrane, and the lower limit is preferable within range from the viewpoint of preventing a decrease in cross-linking rate.

When ethylenic unsaturated groups are reacted to cross-link each other by heat, a thermal polymerization initiator may be used. Examples of the preferable thermal polymerization initiators include peroxide and an azo compound. Specifically, benzoylperoxide, t-butylperoxybenzoate, azobisisobutyronitrile, and the like are included.

The mixture amount of the thermal polymerization initiator to initiate the cross-linking reaction in the present invention is 0.01 to 10 mass%, preferably 0.5 to 7 mass % to the total amount of the mixed solution. The upper limit of the mixture amount is preferable within range from the viewpoint of curing characteristics, mechanical characteristic, and handling characteristics of a composite membrane, and the lower limit is preferable within range from the viewpoint of preventing a decrease in cross-linking rate.

### Polymer Electrolyte Membrane

The polymer electrolyte membrane of the present invention includes the polymer electrolyte composition, and is obtained by applying the mixed solution onto a substrate, drying the substrate to form a coating film, and then initiating a cross-linking reaction in the unsaturated group containing compound consisting of the coating film. The polymer electrolyte membrane of the present invention may contain a conventional filler and dispersion material other than the abovementioned polymer electrolyte composition.

The method for coating the abovementioned mixed solution onto a substrate is not particularly limited; for example, the mixed solution is coated by using means of dies coating, a coater, spray coating, brush coating, roll spin coating, a dip coating, a screen coating, or the like. Thickness and surface smoothness of the film may be controlled by repeatedly coating.

The abovementioned substrate is not particularly limited as far as it is not easily transformed by heat on drying; for example, polyethyleneterephthalate (PET) film, polyethylenenaphthalate (PEN) film, polybutyleneterephthalate (PBT) film, nylon 6 film, nylon 6,6 film, polypropylene film, polytetrafluoroethylene film, and the like are included.

After film-forming by the casting process, the coating film can be formed by drying at 30 to 160 degrees Celsius, preferably 50 to 150 degrees Celsius for 3 to 180 minutes, preferably 5 to 120 minutes. The thickness of the dried film is typically 10 to 100 μm, and more preferably 20 to 80 μm. When solvent remains in the film after dried, it can be desolvated by extracting water if necessary.

After the coating film is formed as described above, the polymer electrolyte membrane of the present invention can be obtained by initiating the cross-linking reaction in the unsaturated group containing compound consisting of the coating film. The cross-linking reaction with the unsaturated group containing compound is as described before. The polymer electrolyte membrane obtained by such a manner maintains high proton conductivity, and exhibits lower solubility to hot water and superior dimensional stability.

### Electrode

A catalyst used in the present invention is preferably a supported catalyst in which a platinum or platinum alloy is supported on a porous carbon material. Carbon blacks or activated carbons may preferably be used for the porous carbon material. Examples of the carbon blacks include channel blacks, furnace blacks, thermal blacks, and acetylene blacks. The activated carbons may be obtained through carbonizing and activating various carbon-containing materials.

A catalyst in which a platinum or platinum alloy is supported on a carbon carrier may be used; and using a platinum alloy may offer stability and activity as an electrode catalyst. Preferably, a platinum alloy is preferably an alloy of platinum and more than one kind of metal selected from the group consisting of platinum group metals other than platinum (i.e., ruthenium, rhodium, palladium, osmium and iridium), cobalt, iron, titanium, gold, silver, chrome, manganese, molybdenum, tungsten, aluminum, silicon, rhenium, zinc and tin. The platinum alloy may include an intermetallic compound of platinum and another metal to be alloyed.

Preferably, the supporting rate of the platinum or platinum alloy (i.e., mass % of platinum or platinum alloy to overall mass of a catalyst) is 20 to 80 mass %, and in particular 30 to 55 mass %, and thus a high output power is obtained within this range. However, when the supporting rate is less than 20 mass %, sufficient output power may not be obtained, and when over 80 mass %, the particles of a platinum or platinum alloy may not be supported on the carbon material that will become the carrier with excellent dispersivity.

The primary particle size of the platinum or the platinum alloy is preferably 1 to 20 nm so as to obtain a highly active gas-diffusion electrode. In particular, the primary particle size is preferably 2 to 5 nm to ensure that the platinum or platinum alloy has a larger surface area from the viewpoint of reaction activity.

The catalyst layer in the present invention includes, in addition to the abovementioned supported catalyst, an ion conductive polymer electrolyte (ion conductive binder) having a sulfonic acid group. Usually, the supported catalyst is covered with the electrolyte, and thus protons (H⁺) travel through the pathway connecting to the electrolyte.

A perfluorocarbon polymer exemplified by Nafion (registered trademark), Flemion (registered trademark) and Aciplex (registered trademark) are appropriately used for an ion conductive polymer electrolyte containing a sulfonic acid group; not only the perfluorocarbon polymer, but also the ion conductive polymer electrolyte containing mainly an aromatic hydrocarbon compound such as the sulfonated polyarylene described herein may be used.

Preferably, the ion conductive binders are included in a mass ratio of 0.1 to 3.0, preferably 0.3 to 2.0, in particular, based on the mass of the catalyst particles. When the ratio of the ion conductive binder is less than 0.1, protons may not be conducted into the electrolyte, and thus possibly resulting in an insufficient power output. When the ratio is more than 3.0, the ion conductive binder may cover the catalyst particles completely, and thus gas cannot reach platinum, possibly resulting in an insufficient power output.

The membrane-electrode assembly according to the present invention may be formed solely of an anodic catalyst layer, a proton conductive membrane, and a cathodic catalyst layer; more preferably, a gas diffusion layer formed of a conductive porous material such as a carbon paper and a carbon cloth is disposed outside the catalyst layer along with the anode and cathode. The gas diffusion layer may act as an electric collector, and therefore, the combination of the gas diffusion layer and the catalyst layer is referred to as an “electrode” herein when the gas diffusion layer is provided.

In a solid polymer electrolyte fuel cell equipped with the membrane-electrode assembly according to the present invention, oxygen-containing gas is supplied to the cathode and hydrogen-containing gas is supplied to the anode. Specifically, a separator having channels for the gas passage is disposed outside both electrodes of the membrane-electrode assembly, gas flows into the passage, and thereby the gas for fuel is supplied to the membrane-electrode assembly.

The method for producing the membrane-electrode assembly may be selected from various methods: The catalyst layer is formed directly on an ion-exchange membrane, sandwiching with the gas diffusion layers as required; The catalyst layer is formed on a substrate for a gas diffusion layer such as a carbon paper, and then the catalyst layer is connected with an ion-exchange membrane; and The catalyst layer is formed on a flat plate, the catalyst layer is transferred onto an ion-exchange membrane, and the flat plate is peeled away, sandwiching with the gas diffusion layers as required.

The method for forming the catalyst layer may be selected from a conventional method. The supported catalyst and a perfluorocarbon polymer having a sulfonic acid group are dispersed into a medium to prepare a dispersion, optionally, a water repellent agent, pore-forming agent, thickener, diluent solvent and the like are added to the dispersion, and then the dispersion is sprayed, coated or filtered on the ion-exchange membrane, the gas-diffusion layer or the flat plate. In cases in which the catalyst layer is not formed on the ion-exchange layer directly, the catalyst layer and the ion-exchange layer are preferably connected by means of a hot press or adhesion process, etc. (See Japanese Unexamined Patent Application Publication No. 07-220741)

### EXAMPLES

The present invention will be explained more specifically with reference to Examples, which are not intended to limit the scope of the present invention. Ion exchange capacity and molecular weight were determined as described below.

(i) Ion Exchange Capacity (IEC)

The resulting sulfonated polymer having a sulfonic acid group was washed until the washed water became neutral, so as to sufficiently remove free residual acid, and then dried. The polymer was then weighed in a predetermined amount and dissolved in a mixed solvent of tetrahydrofuran (THF)/water, then the solution was titrated with a NaOH standard solution, using phenolphthalein as an indicator, and ion exchange capacity (meq/g) was determined from neutralization point.

(ii) Molecular Weight

The molecular weight of the polyarylene with no sulfonic acid group was determined as the molecular weight based on a polystyrene standard by means of gel permeation chromatography (GPC) using THF for the solvent. The molecular weight of the polyarylene having a sulfonic acid group was determined as the molecular weight based on polystyrene standard by means of GPC using N-methyl-2-pyrrolidone (NMP) in which lithium bromide and phosphoric acid were added as eluting solvents.

### Synthesis Example

(i) Synthesis of Hydrophobic Unit

48.8 g (284 mmol) of 2,6-dichlorobenzonitrile, 89.5 g (266 mmol) of 2,2-bis(4-hydroxyphenyl)-1,1,1,3,3,3-hexafluoropropane, 47.8 g (346 mmol) of potassium carbonate were added into a 1 L three-necked flask equipped with a stirrer, a thermometer, a Dean-Stark apparatus, a nitrogen inlet tube, and a cooling pipe. After purging with nitrogen gas, 346 ml of sulfolane and 173 ml of toluene were added and stirred, and then the reaction liquid was heated to and refluxed at 150 degrees Celsius by use of an oil bath. Water generated through the reaction was trapped into the Dean-Stark apparatus. After three hours, when the water generation became nearly zero, the toluene was removed from the Dean-Stark apparatus. The temperature of the reaction mixture was gradually raised to 200 degrees Celsius, stirring was continued for 3 hours, 9.2 g (53 mmol) of 2,6-dichlorobenzonitrile was added, and the mixture was further reacted for another 5 hours. The reaction liquid was allowed to cool and then diluted by adding 100 ml of toluene. Inorganic salts which were insoluble in the reaction liquid were filtered, and then the filtrate was poured into 2 L of methanol to cause precipitation. The precipitated product was filtered, dried, and then dissolved into 250 ml of tetrahydrofuran, and then the solution was poured into 2 L of methanol to cause re-precipitation. The precipitate was filtered and dried, and thereby 109 g of desired product was obtained in white powder. The number average molecular weight (Mn) measured by GPC was 9,500. The resulting compound was an oligomer expressed by the formula (I).

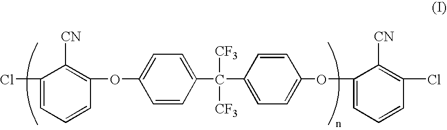

(ii) Synthesis of Sulfonated Polyarylene

135.2 g (337 mmol) of 3-(2,5-dichlorobenzoyl)benzenesulfonic acid neopentyl, 48.7 g (5.1 mmol) of the hydrophobic unit (Mn=9,500) obtained in (i) described above, 6.71 g (10.3 mmol) of bis(triphenylphosphine)nickel dichloride, 1.54 g (10.3 mmol) of sodium iodide, 35.9 g (137 mmol) of triphenylphosphine and 53.7 g (821 mmol) of zinc were added into a 1 L three-necked flask, equipped with a stirrer, a thermometer, and a nitrogen inlet, and then purging with dry nitrogen gas. 430 ml of N,N-dimethylacetamide (DMAc) was added into the mixture, the reaction mixture was maintained at 80 degrees Celsius and was stirred for 3 hours, and then the reaction mixture was diluted with 730 ml of DMAc, and insoluble matter was filtered.

The resulting solution was poured into a 2 L three-necked flask, equipped with a stirrer, a thermometer, and a nitrogen inlet, the solution was stirred while heating at 115 degrees Celsius, and then 44 g (506 mmol) of lithium bromide was added. The mixture was stirred for 7 hours, and then the reaction liquid was poured into 5 L of acetone to precipitate the product. The precipitate was rinsed with 1N HCl and pure water in order, and then dried to obtain the intended polymer of 122 g. The weight average molecular weight (Mw) of the resulting polymer was 135,000. Therefore, the resulting polymer was presumed to be the sulfonated polyarylene expressed by the formula (II). Ion-exchange capacity of the polymer was 2.3 meq/g.

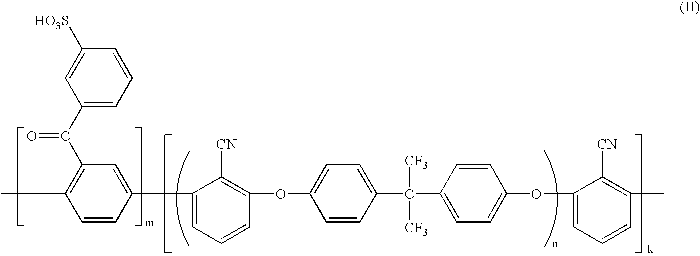

### Example 1

2.00 g of the sulfonated polyarylene obtained in the Synthesis Example and 0.20 g of dipentaerythritol hexaacrylate (“KAYARAD DPHA” produced by NIPPON KAYAKU CO., LTD.) were dissolved in 12.50 g of N-methyl-2-pyrrolidone (NMP) to obtain the mixed solution. The mixed solution was applied onto a PET film by way of cast coating, using an applicator, dried at 120 degrees Celsius for 60 minutes to remove NMP, and thereby a film was formed. The formed film was taken off from the PET film, and set in a metal frame, and then heat at 170 degrees Celsius for 120 minutes to be cross-linking reacted. The film thickness of the obtained provided electrolyte membrane was 40 μm.

### Preparation of Membrane-electrode Assembly

(i) Catalyst Paste

Platinum particles were supported onto a carbon black of (furnace black) having an average particle size of 50 nm at a mass ratio 1:1 of carbon black:platinum to prepare catalyst particles. The catalyst particles were dispersed uniformly into a perfluoroalkylene sulfonic acid polymer compound (Nafion (registered mark), by DuPont) solution as an ion conductive binder in a mass ratio 8:5 of ion conductive binder:catalyst particles, so as to prepare a catalyst paste.

(ii) Gas Diffusion Layer

Carbon black and polytetrafluoroethylene (PTFE) particles were mixed in a mass ratio 4:6 of carbon black:PTFE particles, and the obtained mixture was dispersed uniformly into ethylene glycol to prepare a slurry. Then the slurry was coated on one side of carbon paper and dried to form an underlying layer, and two gas diffusion layers, which were formed of the underlying layer and the carbon paper, were prepared.

(iii) Preparation of Electrode-Coating Membrane (CCM)

The catalyst paste was coated on both sides of the proton conductive membrane prepared in Example 1 by use of a bar coater in content of platinum of 0.5 mg/cm², and was dried to prepare an electrode-coating membrane (CCM). During drying, a first drying step at 100 degrees Celsius for 15 minutes was followed by a second drying step at 140 degrees Celsius for 10 minutes.

(iv) Preparation of Membrane-Electrode Assembly

The CCM was gripped at the side of the underlying layer of the gas diffusion layer, and then was subjected to hot-pressing to obtain a membrane-electrode assembly. During hot-pressing, a first hot-pressing step at 80 degrees Celsius and 5 MPa for 2 minutes was followed by a second hot-pressing step at 160 degrees Celsius and 4 MPa for 1 minute.

In addition, in such a way that the separator, being also usable as a gas passage, is laminated on the gas diffusion layer to construct a solid polymer electrolyte fuel cell from the membrane-electrode assembly according to the present invention.

### Example 2

2.00 g of the sulfonated polyarylene obtained in Synthesis Example, 0.20 g of ethyleneglycol di(metha)acrylate, and 0.07 g of 1-hydroxycyclohexylphenyl ketone as the photo polymerization initiator were dissolved in 12.50g of NMP to obtain the mixed solution. The mixed solution was applied onto a PET film by way of cast coating, using an applicator, dried at 120 degrees Celsius for 60 minutes to remove NMP, and thereby a film was formed. 1.0 J/cm² of ultra violet ray was irradiated onto the formed film to be cross-linking reacted by using a jet printer produced ORC MANUFACTURING CO., LTD. The film thickness of the obtained provided electrolyte membrane was 40 μm.

The membrane-electrode assembly was obtained in the same manner as Example 1, except that the polymer electrolyte membrane obtained in the manner as described above was used.

### Example 3

2.00 g of the sulfonated polyarylene obtained in Synthesis Example and 0.20 g of tripropyleneglycol diacrylate (“KAYARAD KS-TPGDA” produced by NIPPON KAYAKU CO., LTD.) were dissolved in 12.50 g of NMP to obtain the mixed solution. The mixed solution was applied onto a PET film by way of cast coating, using an applicator, dried at 120 degrees Celsius for 60 minutes to remove NMP, and thereby the film was formed. Electron beam (EB) was irradiated at 110 kV of accelerating voltage onto the obtained film to be cross-linking reacted by using “Light Beam-L” produced by IWASAKI ELECTRIC CO., LTD. The film thickness of the obtained provided electrolyte membrane was 40 μm.

The membrane-electrode assembly was obtained in the same manner as Example 1, except that the polymer electrolyte membrane obtained in the manner as described above was used.

### Example 4

2.00 g of the sulfonated polyarylene obtained in Synthesis Example, 0.20 g of divinylbenzene, and 0.02 g of azobisisobutyronitryl as the thermal polimerization initiator were dissolved in 12.50 g of NMP to obtain the mixed solution. The mixed solution was applied onto a PET film by way of cast coating, using an applicator, dried at 120 degrees Celsius for 60 minutes to remove NMP, and thereby the film was formed. The formed film was taken off from the PET film, and set in a metal frame, and then heat at 170 degrees Celsius for 120 minutes to be cross-linking reacted. The film thickness of the obtained provided electrolyte membrane was 40 μm.

The membrane-electrode assembly was obtained in the same manner as Example 1, except that the polymer electrolyte membrane obtained in the manner as described above was used.

### Example 5

2.00 g of the sulfonated polyarylene obtained in Synthesis Example, 0.10 g of divinyladipic acid, and 0.01 g of “Irgacure 184” produced by Ciba Specialty Chemicals as the polimerization initiator were dissolved in 12.50 g of NMP to obtain the mixed solution. The mixed solution was applied onto a PET film by way of cast coating, using an applicator, dried at 120 degrees Celsius for 60 minutes to remove NMP, and thereby the film was formed. Electron beam (EB) was irradiated at 110 kV of accelerating voltage onto the obtained film to be cross-linking reacted by using “Light Beam-L” produced by IWASAKI ELECTRIC CO., LTD. The film thickness of the obtained provided electrolyte membrane was 40 μm.

The membrane-electrode assembly was obtained in the same manner as Example 1, except that the polymer electrolyte membrane obtained in the manner as described above was used.

### Example 6

2.00 g of the sulfonated polyarylene obtained in Synthesis Example, 0.10 g of N,N′-methylenebisacrylamid, and 0.01 g of “Irgacure 369” produced by Ciba Specialty Chemicals as the polimerization initiator were dissolved in 12.50 g of NMP to obtain the mixed solution. The mixed solution was applied onto a PET film by way of cast coating, using an applicator, dried at 120 degrees Celsius for 60 minutes to remove NMP, and thereby the film was formed. 1.0 J/cm² of ultra violet ray was irradiated onto the obtained film to be cross-linking reacted by using a jet printer produced ORC MANUFACTURING CO., LTD. The film thickness of the obtained provided electrolyte membrane was 40 μm.

The membrane-electrode assembly was obtained in the same manner as Example 1, except that the polymer electrolyte membrane obtained in the manner as described above was used.

### Comparative Example 1

15 mass % of sulfonated polyarylene obtained in Synthetic Example was applied onto a PET film by way of cast coating, using an applicator, dried at 120 degrees Celsius for 60 minutes to remove NMP, and thereby the polymer electrolyte membrane with 40 μm thickness was obtained.

The membrane-electrode assembly was obtained in the same manner as Example 1, except that the polymer electrolyte membrane obtained in the manner as described above was used.

### Evaluation

For the electrolyte membrane obtained in the Examples and Comparative Example 1, NMP immersion test, methanol/water solution immersion test, hot water immersion test, and electric resistance measurement were performed. The results are summarized in Table 1.

(i) NMP Immersion Test

The electrolyte membrane obtained from Examples and Comparative Example 1 was cut in 3 cm×3 cm square and then weighed. The membrane was immersed for 24 hours in 50 ml of NMP heated at 80 degrees Celsius, and then observed whether the membrane is soluble to maintain its formation or it is dissolved.

(ii) Methanol/Water Solution Immersion Test

The electrolyte membrane obtained from Examples and Comparative Example 1 was cut in 3 cm×3 cm square and then weighed. The membrane was immersed in 50 ml of 30% by mass of methanol water solution at 50 degrees Celsius for 24 hours. After immersion treatment, the membrane was taken out, droplet was wiped off from on the surface of the membrane, and then the film thickness and the size in face direction of the membrane is measured in condition in which liquid is contained so as to determine increasing rate comparing with the volume before immersion treatment.

(iii) Hot Water Immersion Test

The electrolyte membrane obtained from Examples and Comparative Example 1 was cut in 3 cm×3 cm square and then weighed. The membrane was immersed in 50 ml of distilled water at 95 degrees Celsius for 24 hours. After immersion treatment, the membrane was taken out, droplet was wiped off from on the surface of the membrane, and then the thickness and the size in face direction of the membrane is measured in condition in which liquid is contained, so as to determine increasing rate comparing with the volume before immersion treatment.

(iv) Resistance Measurement

AC resistance was measured by pushing five platinum wires of 0.5 mm diameter onto the surface of the electrolyte membrane which is cut in stripe (40 mm×5 mm) at an interval of 5 mm, disposing the test sample in a controlled temperature/humidity chamber (“JW241” produced by Yamato Scientific Co., Ltd.) and then measuring AC impedance between the platinum wires. The measurement was performed by use of Chemical Impedance Measuring System (by NF Corporation) as a resistance measurement system for AC 10 kHz under conditions of 85 degrees Celsius and a relative humidity of 90%, varying distance between lines within 5 to 20 mm. The specific resistance R of the membrane was then calculated from the slope of the relationship between line distance and resistance according to the expression (1) described below, and then the proton conductivity was determined from the specific resistance R from the expression (2) described below.

$$\begin{matrix}Specific Resistance R ( ohm \cdot cm ) = 0.5 ( cm ) \times Membrane Thickness ( cm ) \times Slope ( ohm \text{/} cm ) & ( 1 ) \\ Proton Conductivity ( S \text{/} cm ) = 1 / Specific Resistance R ( ohm \cdot cm ) & ( 2 )\end{matrix}$$

(v) Electrode Adhesiveness Evaluation

The electrode-coating membrane (hereinafter sometimes referred to as “Catalyst Coated Membrane: CCM”) in which electrodes is applied onto both faces of the polymer electrolyte membrane of the present invention is disposed in a thermal shock chamber with humidity (DCTH-200 produced by ESPEC CORP.), and then cool/heat cycle test (−20 degrees Celsius/85 degrees Celsius at 95% RH) is performed 100 times. The CCM after the test was cut in 1.0 cm×5.0 cm strip and fixed in both sides of an aluminum plate to obtain a test piece. Furthermore, a tape was put on the electrode sides and pulled in direction of 180 degrees at rate of 50 mm/min, and then the electrodes stripped off the CCM. The tape was stripped by using SPG load measuring device HPC.A50.500 made by HOKO ENGINEERING CO., LTD. For the sample after stripping test, an area of the remained electrodes was calculated by way of image processing, and the electrode adhesion rate was determined by the expression (3) described below. Imaging processing was performed by scanning an image with a scanner GT-8200UF produced by SEIKO EPSON CORPORATION, and then bi-tonal digitizating the scanned image.

$$Electrode Adhesiveness ( \% ) = Remained Electrode Area \text{/} Overall Sample Area \qquad ( 3 )$$

(vi) Electricity Generating Property

A membrane-electrode assembly according to the present invention were evaluated with respect to the power generating property under the conditions in which the temperature was 70 degrees Celsius, the relative humidity was 60%/70% on a fuel electrode side/oxygen electrode side, and the current density was 1 A/cm². Pure hydrogen was supplied to the fuel electrode side, and air was supplied to the oxygen electrode side. Furthermore, as evaluation of low temperature startability, the solid polymer electrolyte fuel cell provided with the membrane-electrode assembly was activated 50 times under condition at −30 degrees Celsius; when an amount of performance degration was 20 or less mV at 0.8 A/cm², the membrane-electrode assembly was evaluated as “satisfactory”, while an amount of performance degration was 20 or more mV at 0.8 A/cm², the membrane-electrode assembly was evaluated as “unsatisfactory”.

TABLE 1

| | | | Methanol/Water Solution | | |
|---|---|---|---|---|---|
| | | | Immersion Test | Hot Water Immersion Test | Proton Conductivity |
| | Cross-linking Method | NMP Immersion Test | Volume Increase Rate (%) | Volume Increase Rate (%) | (S/cm) |
| Example 1 | Heat Cross-linking | Insoluble | 20 | 24 | 0.30 |
| Example 2 | UV Cross-linking | Insoluble | 17 | 28 | 0.29 |
| Example 3 | EB Cross-linking | Insoluble | 18 | 39 | 0.29 |
| Example 4 | Heat Cross-linking | Insoluble | 19 | 35 | 0.29 |
| Example 5 | EB Cross-linking | Insoluble | 18 | 31 | 0.30 |
| Example 6 | UV Cross-linking | Insoluble | 19 | 32 | 0.30 |
| Comparative Example | — | Soluble | 95 | 116 | 0.30 |

TABLE 2

| | | Power | |
|---|---|---|---|
| | | Generating | Low |
| | Electrode | Performance | Temperature |
| | Adhesiveness (%) | (V) | Resistance |
| Example 1 | 100 | 0.653 | Satisfactory |
| Example 2 | 100 | 0.648 | Satisfactory |
| Example 3 | 100 | 0.649 | Satisfactory |
| Example 4 | 100 | 0.645 | Satisfactory |
| Example 5 | 100 | 0.652 | Satisfactory |
| Example 6 | 100 | 0.651 | Satisfactory |
| Comparative Example | 90 | 0.654 | Unsatisfactory |

Proton conductivity of the polymer electrolyte membrane from Examples, in which the compound containing multiple ethylenic unsaturated groups was cross-linking reacted, was equivalent to that of the polymer electrolyte with no cross-linking from Comparative Example 1. In addition, the polymer electrolyte exhibits superior dimensional stability to high temperature hot water generated when the solid polymer electrolyte fuel cell generated power electricity. Furthermore, since the membrane-electrode assembly exhibits dimensional stability to improve adhesiveness of membrane-electrode interface, stripping the electrodes was inhibited by shrinking the solid polymer electrolyte membrane at a low temperature, and performance deterioration of the membrane-electrode assembly can be inhibited after the membrane-electrode assembly was used in a low temperature history, resulting in that the membrane-electrode assembly exhibiting superior power generation performance and durability even under a low temperature environment was obtained.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A membrane-electrode assembly for solid polymer electrolyte fuel cells, comprising:
an anode electrode,
a cathode electrode, and
a solid polymer electrolyte membrane,
the anode electrode and the cathode electrode being disposed on opposite sides of the solid polymer electrolyte membrane, wherein
the solid polymer electrolyte membrane includes a polymer electrolyte composition consisting of a polymer having a cross-linking structure, the solid polymer electrolyte composition being obtained from a mixed solution including a polymer electrolyte containing a protonic acid group, a compound containing a plurality of ethylenic unsaturated groups, and a solvent.

2. The membrane-electrode assembly for solid polymer electrolyte fuel cells according to claim 1, wherein the compound containing the plurality of ethylenic unsaturated groups is a polyfunctional unsaturated monomer containing a plurality of (metha)acryloyl groups or vinyl groups in its molecule.

3. The membrane-electrode assembly for solid polymer electrolyte fuel cells according to claim 1, wherein the solid polymer electrolyte containing the protonic acid group includes a sulfonated polyarylene having constitutional units expressed by the general formulas (A) and (B) shown below: 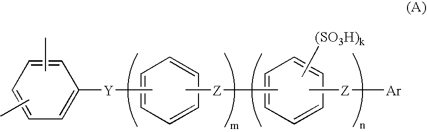
in which, in formula (A) Y represents —CO—, —SO₂—, —SO—, —CONH—, —COO—, —(CF₂)ᵢ— (i is an integer from 1 to 10) and —C(CF₃)₂—; Z independently represents a direct bond, —O—, —S—, —(CH₂)ⱼ— (j is an integer from 1 to 10), and —C(CH₃)₂—; Ar represents an aromatic group having a substituent expressed by —SO₃H, —O(CH₂)ₚSO₃H or —O(CF₂)ₚSO₃H (p is an integer from 1 to 12); m is an integer from 0 to 10; n is an integer from 0 to 10; and k is an integer from 1 to 4, and 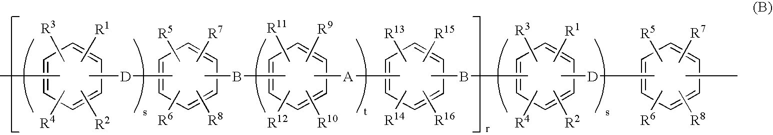
in which, in formula (B) A and D each independently represents a direct bond, —O—, —S—, —CO—, —SO₂—, —SO—, —CONH—, —COO—, —(CF₂)ᵢ— (i represents an integer from 1 to 10), —(CH₂)ⱼ— (j represents an integer from 1 to 10), —CR′₂— (R′ represents an aliphatic hydrocarbon group, aromatic hydrocarbon group, or halogenated hydrocarbon group), cyclohexylidene group, or fluorenylidene group; B independently represents an oxygen atom or sulfur atom; R¹ to R¹⁶ each independently represents a hydrogen atom, fluorine atom, alkyl group, partly or fully halogenated alkyl group, allyl group, aryl group, nitro group or nitrile group; s and t are integers from 0 to 4; and r is an integer of 0 or more.

4. The membrane-electrode assembly for solid polymer electrolyte fuel cells according to claim 3, wherein the sulfonated polyarylene has an ion exchange capacity of 0.3 to 5 meq/g.

5. The membrane-electrode assembly for solid polymer electrolyte fuel cells according to claim 3, wherein the sulfonated polyarylene has a molecular weight of 10,000 to 1,000,000.

6. The membrane-electrode assembly for solid polymer electrolyte fuel cells according to claim 1, wherein the mixed solution has a viscosity of 1,000 to 20,000 mPa·s.

7. The membrane-electrode assembly for solid polymer electrolyte fuel cells according to claim 1, wherein the mixed solution further contains a polymerization initiator.

8. The membrane-electrode assembly for solid polymer electrolyte fuel cells according to claim 7, wherein the polymerization initiator generates a radical by being decomposed by way of photoirradiation.

9. The membrane-electrode assembly for solid polymer electrolyte fuel cells according to claim 7, wherein the polymerization initiator is a thermal polymerization initiator.

10. The membrane-electrode assembly for solid polymer electrolyte fuel cells according to claim 1, wherein the polymer having a cross-linking structure is obtained by initiating a cross-linking reaction in the compound containing the plurality of ethylenic unsaturated groups that constitutes the mixed solution.

11. The membrane-electrode assembly for solid polymer electrolyte fuel cells according to claim 6, wherein the polymer having a cross-linking structure is obtained by initiating a cross-linking reaction in the compound containing the plurality of ethylenic unsaturated groups that constitutes the mixed solution.

12. The membrane-electrode assembly for solid polymer electrolyte fuel cells according to claim 7, wherein the polymer having a cross-linking structure is obtained by initiating a cross-linking reaction in the compound containing the plurality of ethylenic unsaturated groups that constitutes the mixed solution.

13. The membrane-electrode assembly for solid polymer electrolyte fuel cells according to claim 8, wherein the polymer having a cross-linking structure is obtained by initiating a cross-linking reaction in the compound containing the plurality of ethylenic unsaturated groups that constitutes the mixed solution.

14. The membrane-electrode assembly for solid polymer electrolyte fuel cells according to claim 9, wherein the polymer having a cross-linking structure is obtained by initiating a cross-linking reaction in the compound containing the plurality of ethylenic unsaturated groups that constitutes the mixed solution.

15. A method for producing a membrane-electrode assembly for solid polymer electrolyte fuel cells, comprising steps of:
applying the mixed solution according to claim 1 onto a substrate to form a dried coating film; and
initiating a cross-linking reaction in the compound containing a plurality of ethylenic unsaturated groups that forms the coating film.

16. A method for producing a membrane-electrode assembly for solid polymer electrolyte fuel cells, comprising steps of:
applying the mixed solution according to claim 6 onto a substrate to form a dried coating film; and
initiating a cross-linking reaction in the compound containing the plurality of ethylenic unsaturated groups that forms the coating film.

17. A method for producing a membrane-electrode assembly for solid polymer electrolyte fuel cells, comprising steps of:
applying the mixed solution according to claim 7 onto a substrate to form a dried coating film; and
initiating a cross-linking reaction in the compound containing the plurality of ethylenic unsaturated groups that forms the coating film.

18. A method for producing a membrane-electrode assembly for solid polymer electrolyte fuel cells, comprising steps of:
applying the mixed solution according to claim 8 onto a substrate to form a dried coating film; and
initiating a cross-linking reaction in the compound containing the plurality of ethylenic unsaturated groups that forms the coating film.

19. A method for producing a membrane-electrode assembly for solid polymer electrolyte fuel cells, comprising steps of:
applying the mixed solution according to claim 9 onto a substrate to form a dried coating film; and
initiating a cross-linking reaction in the compound containing the plurality of ethylenic unsaturated groups that forms the coating film.
